(19) United States
(12) Patent Application Publication
(10) Pub. No.: US 2010/0302586 A1
(43) Pub. Date: Dec. 2, 2010

(54) IMAGE FORMING APPARATUS, SERVER APPARATUS AND RECORDING MEDIUM

(75) Inventors: Kazusei Takahashi, Nishinomiya-shi (JP); Hisashi Uchida, Kuze-gun (JP); Yoshiyuki Tamai, Itami-shi (JP); Masaya Hashimoto, Itami-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 12/789,598

(22) Filed: May 28, 2010

(30) Foreign Application Priority Data
May 29, 2009 (JP) 2009-131390

(51) Int. Cl. G06F 3/12; G06F 3/00; G06F 15/16

(52) U.S. Cl. 358/1.15; 715/716; 709/219

(57) ABSTRACT

An image forming apparatus includes: a communicator that is capable of communicating with a support terminal for operation support about the image forming apparatus; a controller that records video data consisting of data exchanged with the support terminal in a memory and further records voice data consisting of a conversation between a user who operates the image forming apparatus and the support staff, also in the memory, with a connection to the video data; and a player that plays the video and voice data recorded therein, according to an instruction given by the user or another user.

This application claims priority under 35 U.S.C. §119 to Japanese Patent Application No. 2009-131390 filed on May 29, 2009, the entire disclosure of which is incorporated herein by reference in its entirety.

### BACKGROUND OF THE INVENTION

1. Field of the Invention

The present invention relates to an image forming apparatus having the support function to support user operations; a server apparatus existing in a communication network between the image forming apparatus and a support terminal operated by a support staff who is in charge of operation support about the image forming apparatus; and a computer readable recording medium having a program recorded therein to make a computer execute processing.

2. Description of the Related Art

The following description sets forth the inventor's knowledge of related art and problems therein and should not be construed as an admission of knowledge in the prior art.

Operation method of the MFPs (Multi Function Peripherals) that are multifunctional digital machines collectively having the copy function, the print function, the scan function and other functions has been complicated due to the improvement in functionality. And thus, now it is more difficult to support users who are not familiar with how to operate the MFPs, even if more detail information is simply added in conventional paper manuals that have been used to explain how to operate the MFPs.

As disclosed in Japanese Unexamined Laid-open Patent Publication No. H11-191822, there is a technology to display an operation guidance in a help guidance screen when a user encounters a trouble, so that the user could resolve this trouble by himself/herself. Also, as disclosed in Japanese Unexamined Laid-open Patent Publication No. 2002-041196, there is a technology to display help guidance information in a prepared video, when a user calls out the help function.

Furthermore, manufacturers and retailers upload FAQ (Frequently Asked Questions) onto their Websites, so that users could view information not included in their manuals.

Furthermore, manufacturers and retailers have their own support centers to have their support staff answer user inquiries.

However, there are still some problems with the solutions suggested above, as the following.

By using the technology to display an operation guidance in a help guidance screen and the technology to display help guidance information in a prepared video, users can take more information than a paper manual. However, it is difficult to prepare a digital manual that satisfies all users in various knowledge and experience levels, just like preparing such a paper manual.

The method of uploading FAQ onto a Website is effective to provide information that is not included in a manual. However, if new functions are added to a MFP and now users have to mind more combinations of operations, it is not easy to keep the FAQ page always updated.

The method of having support staff answer user inquiries by one-to-one communication seems to be more effective than the technologies and method mentioned above. However, one-to-one communication costs too much and if users have to pay the costs, they would not feel like making inquiries casually. On the other hand, if manufacturers and retailers have to pay the costs, they would limit the number of support staff and users would have difficulties in getting through or getting prompt answers from them.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the present invention to provide an image forming apparatus that is capable of providing suitable help information to a user who encounters an operation trouble, without requiring the user to keep many operation manuals or without using the method of uploading FAQ onto a Website or having staff in support centers answer every operation trouble by one-to-one communication.

It is another object of the present invention to provide a server apparatus that is capable of providing suitable help information to a user who encounters an operation trouble, without requiring the user to keep many operation manuals or without using the method of uploading FAQ onto a Website or having staff in support centers answer every operation trouble by one-to-one communication.

It is yet another object of the present invention to provide a computer readable recording medium having a program recorded therein to make computers of an image forming apparatus and a server apparatus, execute predetermined procedures.

According to a first aspect of the present invention, an image forming apparatus includes:
a communicator that is capable of communicating with a support terminal operated by a support staff who is in charge of operation support about the image forming apparatus;
a controller that records video data consisting of data exchanged with the support terminal by the communicator, in an internal or external memory of the image forming apparatus, and further records voice data consisting of a conversation between a user who operates the image forming apparatus and the support staff, also in the internal or external memory, with a connection to the video data; and a player that plays the video and voice data recorded therein, according to an instruction given by the user or another user.

According to a second aspect of the present invention, an image forming apparatus includes:
a controller that records video data consisting of operation screens displayed with operations of a user who operates the image forming apparatus, in an internal or external memory of the image forming apparatus, and further records voice data consisting of a conversation between the user and a support staff, also in the internal or external memory, with a connection to the video data; and
a player that plays the video and voice data recorded therein, according to an instruction given by the user or another user.

According to a third aspect of the present invention, a server apparatus existing in a communication pathway between an image forming apparatus and a support terminal of a support staff who is in charge of operation support about the image forming apparatus, includes:
a communicator that is capable of communicating with the image forming apparatus and the support terminal;
a controller that records video data consisting of data exchanged between the image forming apparatus and the support terminal and obtained by the communicator, in an internal or external memory of the server apparatus, and further records voice data consisting of a conversation between a user who operates the image forming apparatus and the support staff, also in the internal or external memory, with a connection to the video data; and
a transmitter that transmits the video and voice data recorded therein to the image forming apparatus or another image forming apparatus, according to an instruction received therefrom.

According to a forth aspect of the present invention, a computer readable recording medium has a program recorded therein to make a computer of an image forming apparatus execute:
communicating with a support terminal operated by a support staff who is in charge of operation support about the image forming apparatus;
recording video data consisting of data exchanged with the support terminal, in an internal or external memory of the image forming apparatus, and further recording voice data consisting of a conversation between a user who operates the image forming apparatus and the support staff, also in the internal or external memory, with a connection to the video data; and
playing the video and voice data recorded therein, according to an instruction given by the user or another user.

According to a fifth aspect of the present invention, a computer readable recording medium has a program recorded therein to make a computer of an image forming apparatus execute:
recording video data consisting of operation screens displayed with operations of a user who operates the image forming apparatus, in an internal or external memory of the image forming apparatus; and
playing the video data recorded therein, according to an instruction given by the user or another user.

According to a sixth aspect of the present invention, a computer readable recording medium has a program recorded therein to make a server apparatus existing in a communication pathway between an image forming apparatus and a support terminal of a support staff who is in charge of operation support about the image forming apparatus, execute:
communicating with the image forming apparatus and the support terminal;
recording video data consisting of data exchanged between the image forming apparatus and the support terminal, in an internal or external memory of the image forming apparatus, and further recording voice data consisting of a conversation between a user who operates the image forming apparatus and the support staff, also in the internal or external memory, with a connection to the video data; and
transmitting the video and voice data recorded therein to the image forming apparatus or another image forming apparatus, according to an instruction received therefrom.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram schematically showing a configuration of an image forming apparatus (MFP) according to one embodiment of the present invention;

FIG. 2 is a view showing a configuration of a support system in which the MFP shown in FIG. 1 is employed;

FIG. 3 is a view showing an example of user operations;

FIG. 4 is a view showing another example of user operations;

FIG. 5 is a view showing yet another example of user operations;

FIG. 6 is a view showing still yet another example of user operations;

FIG. 7 shows records of help information displayed in a view format in a screen on a display;

FIG. 8 is a flowchart representing an example of a procedure executed in the MFP;

FIG. 9 is a flowchart continued from FIG. 8;

FIG. 10 is a view showing a screen to play video data including masked confidential information;

FIG. 11 is a view showing another screen to play video data including masked confidential information;

FIG. 12 is a view showing a comment entry screen;

FIG. 13 is a view showing other records or help information displayed in a screen on a display;

FIG. 14 is a flowchart to explain a procedure executed in the MFP in another embodiment of the present invention;

FIG. 15 is a flowchart continued from FIG. 14;

FIG. 16 is a view showing a registration screen to additionally register a user who is allowed to view a playback of a disclosed version of video data;

FIG. 17 is a flowchart to explain a procedure executed in the MFP in yet another embodiment of the present invention;

FIG. 18 is a view showing a configuration of the entire support system according to still yet another embodiment of the present invention; and

FIG. 19 is a flowchart representing a procedure executed in a server in the support system of FIG. 18.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

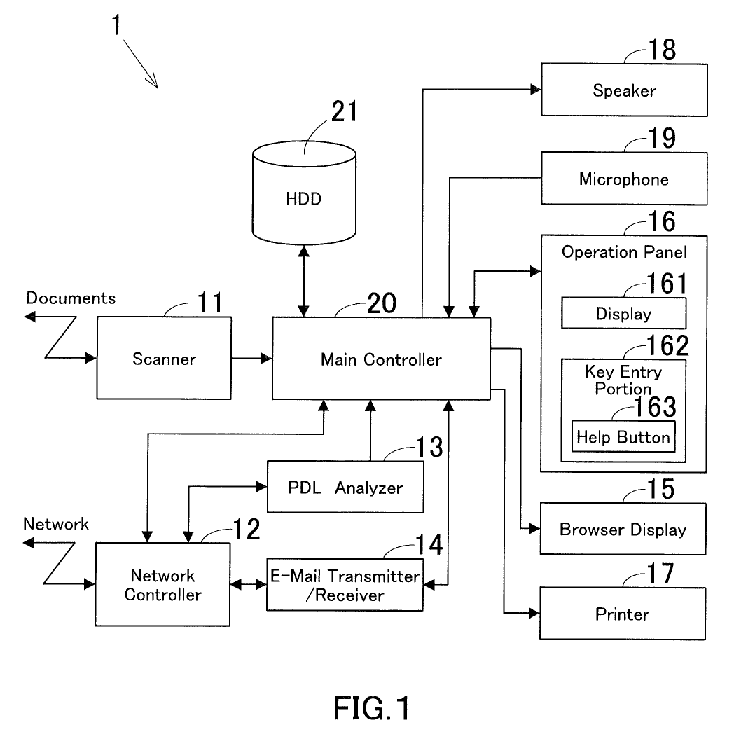

FIG. 1 is a block diagram schematically showing a configuration of an image forming apparatus according to one embodiment of the present invention. In this embodiment, a MFP 1 that is one of the multifunctional digital machines previously mentioned is employed as an image forming apparatus. Hereinafter, an image forming apparatus will be referred to as “MFP”.

The MFP 1 includes a scanner 11, a network controller 12, a printer description language (PDL: Printer Description Language) analyzer 13, an electronic mail (e-mail) transmitter/receiver 14, a browser display 15, an operation panel 16, a printer 17, a speaker 18, a microphone 19, a main controller 20, a memory 21 and etc.

The scanner 11 reads an image of a document placed on a document table (not shown in Figure) and transfers image data obtained from the document to the main controller 20.

The network controller 12 serves as a communicator to transmit/receive packet data to/from a network such as LAN (Local Area Network), and transfers packet data to the PDL analyzer 13 or the e-mail transmitter/receiver 14.

The PDL analyzer 31 analyzes print data received by the network controller 12 from a user terminal or another device, converts the print data into image data, and gives the image data to the main controller 20.

The e-mail transmitter/receiver 14 converts a document received by electronic mail from a user terminal or another device via a network, and gives to processors of the main controller 20.

The browser display 15 displays a browser screen on itself.

The operation panel 16 includes: a display 161 that displays on itself a login screen, a screen about Boxes that are memory areas of the memory 21, various messages, a state of the apparatus and other information; and a key entry portion 162 that has a numeric key pad, a start key, a stop key and other keys and transfers information entered thereby to input portions of the main controller 20 and the display 161. Furthermore, in this embodiment, the operation panel 16 also includes a help button 163 to request for operation support when a user encounters an operation trouble. This help button 163 may be provided on the display 161 as an independent key or a touch button.

The printer 17 prints out on paper document data, for example image data read out from a document by the scanner 11 and print data received from a personal computer (hereinafter will be referred to as “PC”) such as a user terminal.

The speaker 18 plays voice data for users, and the microphone 19 obtains voice data from users and transfers it to the main controller 20.

The main controller 20 centrally controls the entire MFP 1. In addition, in this embodiment, the main controller 20 records video data consisting of operation screens that are displayed when a user who operates the MFP 1 perform communication for support service, with a support staff who operates a support terminal in a support center, in the memory 21 or an external memory. Furthermore, the main controller 20 records voice data consisting of a conversation between the user and the support staff, also in the memory 21 or an external memory, with a connection to the video data, and performs other operations about operation support. Explanation thereof will be detailed later.

The main controller 20 includes a CPU, a ROM that is a memory recording an operation program for the CPU, a RAM that is a memory providing a work area for the CPU to execute processing according to the operation program, and etc.

The memory 21 is a recording medium such as a hard disk driver (HDD). It records in itself: document data administered by the main controller 20; control data necessary to control the entire MFP 1; video and voice data such as previously mentioned; user information that are user attributes to identify users; staff information of support staff in support centers; and other data. Furthermore, the memory 21 has one or more than one Box that is a memory area and records data in a Box related to the data.

The display 161 of the operation panel 16 and the browser display 15 may be consolidated in one same display device or may be provided independently.

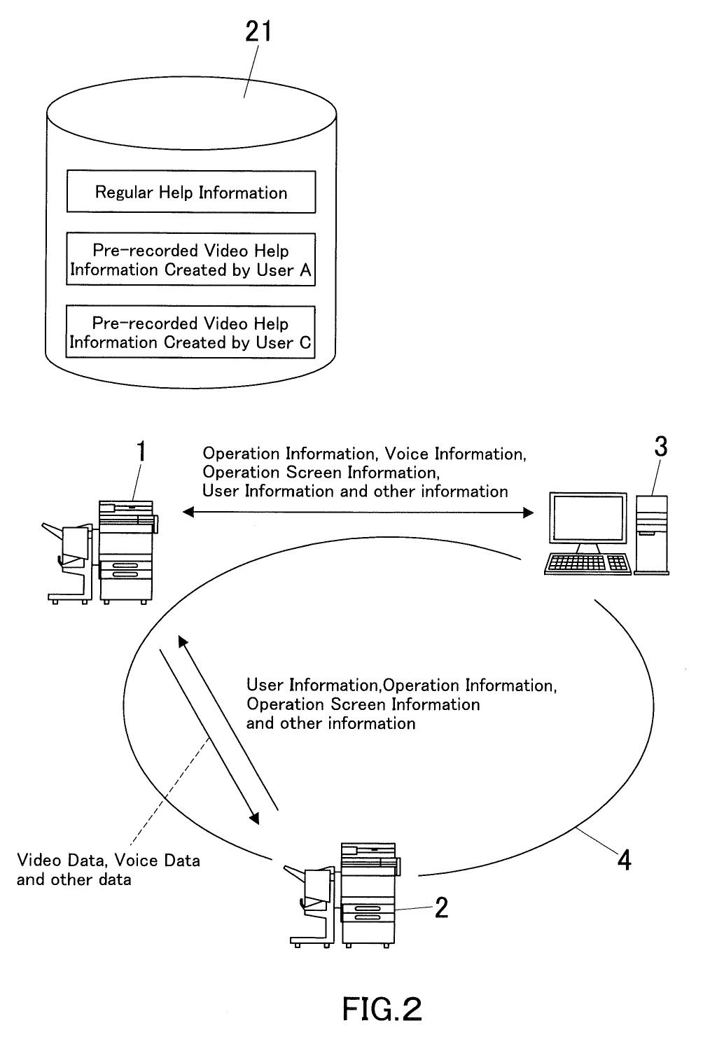

FIG. 2 is a view showing a configuration of a support system in which the MFP 1 of FIG. 1 is employed.

As shown in FIG. 2, the support system includes the MFP 1, a MFP 2 and a support terminal 3 operated by a support staff in a support center. The MFP 1, the MFP 2 and the support terminal 3 are interconnected via a network 4. The MFP 1 and the MFP 2 have a common configuration.

Hereinafter, an overview of operations performed in the support system shown in FIG. 2, will be explained.

Operation information indicating that a user who operates the MFP 1 performed entry operations via the operation panel 16 (for example, the user pressed an operation key and entered a location where to store image data), are transmitted to the main controller 20. And it is judged by the main controller 20, that the user pressed the help button 163, then the selection buttons: “Contact Support Center” and “Show Pre-recorded Video Help Information”, are displayed on the display 161 of the operation panel 16.

It is judged that the user selects the “Contact Support Center” button, then the staff information stored in the memory 21 and the user's operation state included in the operation information are compared to each other, and thus a suitable support staff is selected. And an access to the suitable support staff is tried via the network controller 12.

An access to the suitable support staff is successfully made. Then, ID information of the MFP 1, the operation information, operation screen information, voice data and other data are exchanged between the MFP 1 operated by the user and the support terminal 3 operated by the support staff.

In other words, an operation state and operation content are transmitted to the support terminal 3, and an operation state and operation content explained by the support staff are returned to the main controller 20, via the network controller 12.

If the user operates the MFP 1, the user's operation information is transmitted to the main controller 20, from the operation panel 16 thereof. Meanwhile, if the support staff remotely operates the MFP 1, the support staff's operation information is transmitted to the main controller 20, from the support terminal 3, via the network 4 and the network controller 12.

The user's voice entered from the microphone 19 of the MFP 1 is transmitted to the support terminal 3 via the network controller 12. Meanwhile, the support staff's voice is transmitted to the MFP 1 via the network 4, received by the network controller 12, and transferred to the main controller 20. And the voice data is further transferred to the speaker 18 of the MFP 1.

While the user receives the support from the support staff, the operation information is analyzed by the main controller 20, then transmitted to the memory 21, together with the operation screen information and other data. Also, voice communication information (the voice data) exchanged between the user and the support staff, is also transmitted to the memory 21. Under the control of the main controller 20, the operation screen information and other data exchanged between the MFP 1 and the support terminal 3 are recorded as the video data in the memory 21, and the voice data is also recorded in the memory 21 with a connection to the video data. Furthermore, the user's user information is recorded in the memory 21 with a connection to the video data, and the operation information until the user presses the help button 163 and the operation information after the user finishes communicating the support center, is also recorded in the memory 21 an operation log with a connection to the video data.

After completion of user support, video data consisting of the operation screen information and other data is analyzed by the main controller 20, and based on the analysis, a title is automatically created for the video data, and the user's operation level is automatically judged based on the operation log. And the title of the video data and the user's operation level are displayed for the user and the support staff. The user and the support staff check the title and the operation level, and if need to revise them, the user or the support staff enters an appropriate title and operation level, via the operation panel 16 or the network controller 12, respectively. And accordingly, the automatically created title and the automatically determined operation level are revised by the controller 20.

The finally determined title and a comment that corresponds to the finally determined operation level are recorded in the memory 21 of the MFP 1, with a connection to the video data.

As described above, video data, voice data, user information, an operation log, a title, a comment and other data are consolidated into one record of pre-recorded video help information and recorded in the memory 21. In this way, a plurality of records of pre-recorded video help information are created and recorded in advance in the memory 21.

The records of pre-recorded video help information, each including video data, voice data, user information, an operation log, a title, a comment and other data, may be recorded in advance in a recording medium other than the memory 21 of the MFP 1, for example, may be recorded in advance in a memory of the MFP 2 or a memory of a server apparatus. A request to record in another recording medium is also given by the main controller 20.

In this embodiment, as for the video data stored in the memory 21 by the main controller 20, there are two types of video data: first video data including confidential information such as a user ID, an electronic mail address, a document title and a preview image, which is masked, and second video data including confidential information that is unmasked. Contents of the confidential information can be specified in advance.

The user selects the “Show Pre-recorded Video Help Information” button among those displayed after pressing the help button 163, and this action is detected by the main controller 20. And any record that includes an operation log corresponding to the operations performed by the user for operation support until pressing the help button 163, is detected among the plurality of records of pre-recorded video help information recorded in the memory 21. Here, “an operation log corresponding to the operations” means that an operation log may entirely correspond to the operations or may partially correspond to the operations. In this embodiment, in addition to the records of pre-recorded video help information, some records of regular help information consisting of video data and a prepared regular video manual are also recorded in the memory 21. And thus, any record that includes an operation log corresponding to the operations performed by the user for operation support is detected among those of pre-recorded video help information and regular help information.

If no such record is detected, a request for the record is transmitted to the MFP 2 and the server via the network controller 12. And the record is received therefrom and displayed for the user on the display 161 of the operation panel 16.

If such record(s) is(are) detected, the record(s) is(are) displayed in a view format with a message requesting the user to select among them. If it is a record of regular help information, its title, comment (“How to Copy—Detail” in the example of FIG. 7), and one of the operation screens are displayed. If it is a record of pre-recorded video help information, its title, comment (“Intermediate Operation Level” or “Advanced Operation Level” in the example of FIG. 7), one of the operation screens, the number of past users, an average score indicating usability of the record, and other information are displayed. The average score is an averaged value of the scores entered by the past users who have ever used the record of pre-recorded video help information.

Subsequently, the user selects among the one or more than one record displayed in a view format, and it is judged that an instruction to play video and voice data is given. Then, the video data included in the record is displayed (played) on the display 161 of the operation panel 16, and the voice data also included in the record is played by the speaker 18. If it is a record of pre-recorded video help information, then it is judged by the main controller 20, whether the first video data including closed confidential information or the second video data including disclosed confidential information to display for the user who gave an instruction to play video and voice data (the login user), by comparing the user's user information to the user information included in the record of pre-recorded video help information. As well as the user who created the record of pre-recorded video help information itself, users who are allowed to know the confidential information are also registered for the record. And according to the registered information, it is judged whether the first video data or the second video data to display for the user who gave an instruction to play video and voice data.

Instead of recording in advance the first video data and the second video data in the memory 21, only video data including unmasked confidential information may be recorded in the memory 21, so that the video data including the confidential information that is masked or kept unmasked depending on the user who gave an instruction to play the video data, later could be played.

In this embodiment, when there is a request for operation support from the MFP 2, user information, operation information, operation screen information and other information are obtained from the MFP 2. And any record that includes the operation information, is detected among the records of pre-recorded video help information and regular help information recorded in the memory 21, and the record is transmitted to the MFP 2 so that it could be displayed in a view format. And when there is from the MFP 2, a request to play video and voice data included in the record, the video and voice data are transmitted to the MFP 2.

Hereinafter, operations of the MFP 1 employed in the support system of FIG. 2 will be explained.

When User A loses his/her way in operating the MFP 1, he/she accesses the support center to know how to continue operation. And as described above, the MFP 1 records video data consisting of operation screen information and other data in the memory 21, and further records voice data consisting of a conversation between the User A and a support staff, user information, an operation log and other data in the memory 21, with a connection to the video data.

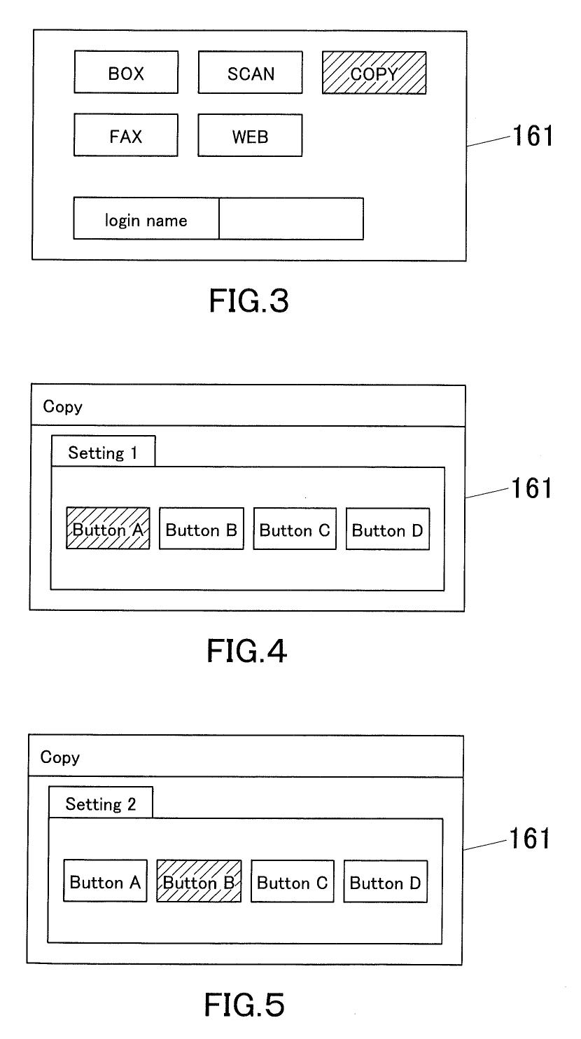

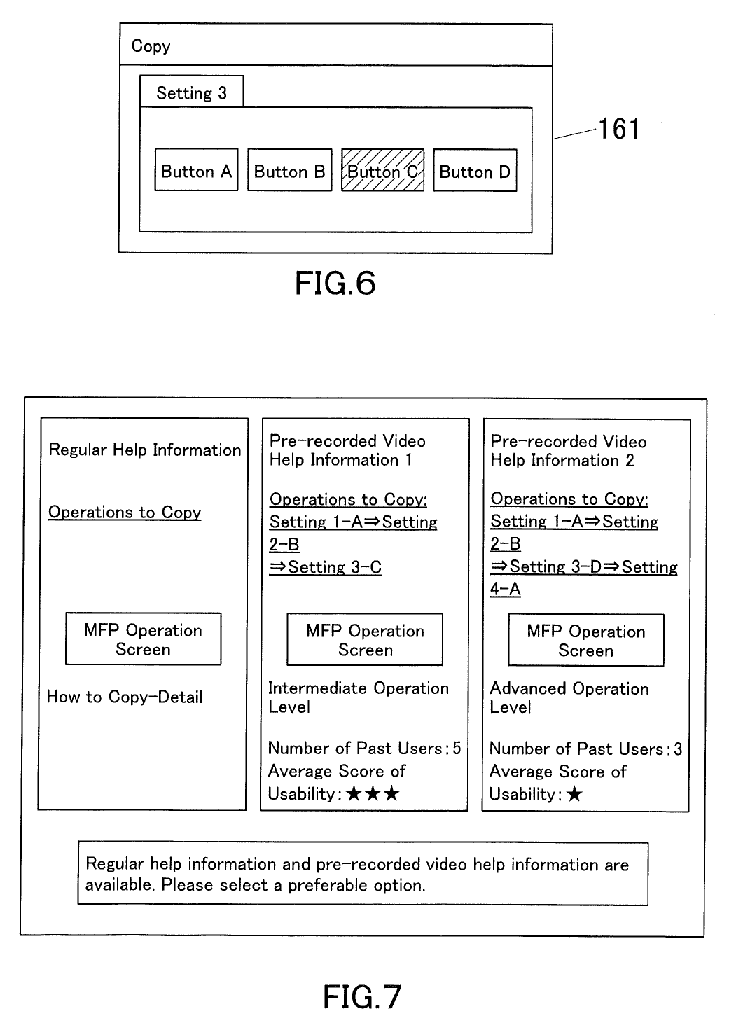

For example, if the User A performs operations as shown in FIG. 3 through FIG. 6, the MFP 1 creates an operation log indicating that the “COPY” button, the button A in Setting 1, the button B in Setting 2 and the button C in Setting 3 are pressed in this order, and records the operation log with a connection to the video data.

The main controller 20 of the MFP 1 records both two types of video data: first video data (video with closed confidential information) including confidential information such as a user login name, a password, an electronic mail address, a document title and a preview image, which is masked, and second video data (video with disclosed confidential information) including confidential information that is unmasked.

The main controller 20 automatically creates a title of the video data and a comment that corresponds to the user's operation level, and records them with a connection to the video data. In the example described above, the main controller 20 judges that the user's operation level is “intermediate” for example, among the levels “introductory”, “beginner”, “intermediate” and “advanced”, based on the entry in “Setting 2” and “Setting 3”, and then records the title of the video as “COPY: button A in Setting 1→button B in Setting 2→button C in Setting 3” and records the comment as “intermediate operation level”.

The title and the comment will be disclosed as well as the video data. However, if the User A who performed operations and the support staff judge that the title and the comment are not appropriate, they can revise them. Furthermore, they can add another comment. The title and comment revised and the comment added by them will be recorded with a connection to the video data, and disclosed.

The User A may select whether in a Box of the memory 21 or in an external device such as an external server, to record the video data, the voice data and other data. Alternatively, the user A may specify in advance a location where to record them, by operating the MFP 1.

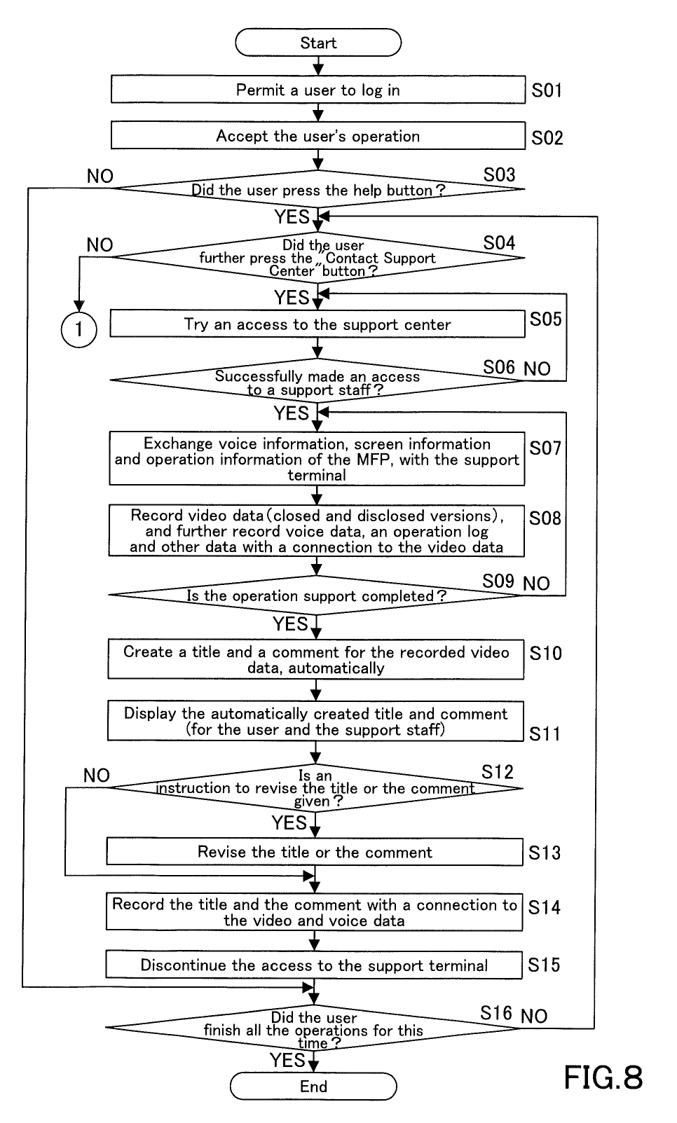

With reference to a flowchart shown in FIG. 8, an example of a procedure executed in the MFP 1 will be explained. This procedure is executed by the CPU of the main controller 20 of the MFP 1, according to an operation program recorded in a recording medium such as the ROM or the memory 21.

A user is permitted to log in the MFP 1 in Step S01, and this user's operation is accepted in Step S02.

In Step S03, it is judged whether or not the user pressed the help button 163. If the user did not (NO in Step S03), the routine proceeds to Step S16.

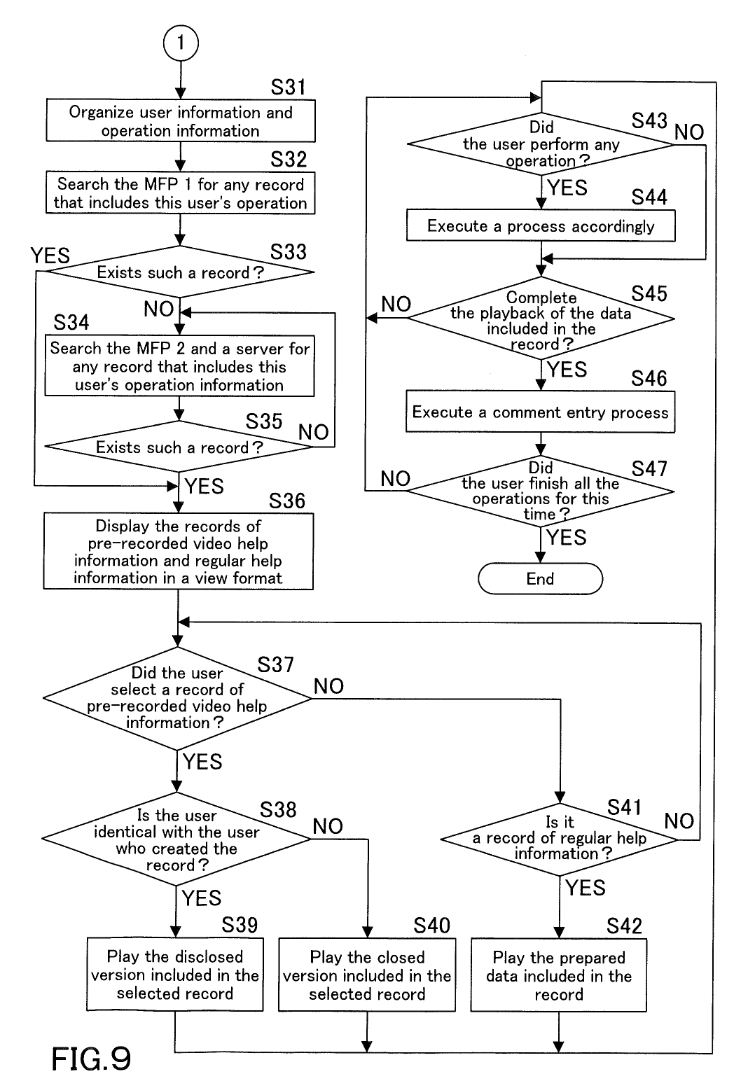

If the user presses the button (YES in Step S03), the selection buttons “Contact Support Center” and “Show Pre-recorded Video Help Information” are displayed on the display 161, and then it is judged in Step S04, which button the user pressed. If it is the “Show Pre-recorded Video Help Information” button (NO in Step S04), the routine proceeds to Step S31 of FIG. 9. If it is the “Contact Support Center” button (YES in Step S04), an access to the support center is tried in Step S05.

In Step S06, it is judged whether or not an access to the support terminal 3 operated by the support staff is successfully made. If it is not successfully made (NO in Step S06), the routine goes back to Step S05. If it is successfully made (YES in Step S06), voice information, screen information and operation information of the MFP 1 are exchanged with the support terminal 3, in Step S07. And in Step S08, a process to record video data consisting of operation screen information and other information, voice data consisting of voice information in the memory 21 with a connection to each other, is executed, and a process to record an operation log, user information and other data in the memory 21 with a connection to the video data, is also executed. As for the video data stored in the memory 21, there are two types of video data: a closed version of video data including masked confidential information and a disclosed version of video data including unmasked confidential information.

Subsequently, it is judged in Step S09, whether or not the operation support is completed. If it is not completed yet (NO in Step S09), the routine goes back to Step S07. If it is completed (YES in Step S09), a title and a comment are automatically created for the video data recorded therein, in Step S10. And the automatically created title and comment are displayed on the display 161 and also transmitted to the support terminal 3, so that the user and the support staff could know them, in Step S11. Then it is judged in Step S12, whether or not an instruction to revise the title or the comment is given.

If such an instruction is given (YES in Step S12), a process to revise the title or the comment is executed in Step S13, then the routine proceeds to Step S14. If such an instruction is not given (NO in Step S12), the routine proceeds directly to Step S14.

In Step S14, the title and the comment are recorded with a connection to the video and voice data. After that, the access to the support terminal 3 is discontinued in Step S15, and it is judged in Step S16, whether or not the user finished all the operations for this time.

If the user did not finish yet (NO in Step S16), the routine goes back to Step S04. If the user finished (YES in Step S16), the routine terminates.

Meanwhile, in Step S31 of FIG. 9, user information of the user who pressed the “Show Pre-recorded Video Help Information” button and operation information indicating operations performed by the user are organized. And in Step S32, the memory 21 of the MFP 1 is searched for any record of pre-recorded video help information and regular help information, which includes this user's operation information. And it is judged in Step S33, whether or not there is such a record.

If there is such a record (YES in Step S33), the routine proceeds to Step S36. If there is no such record (NO in Step S33), other external devices such as the MFP 2 and a server are further searched in Step S34.

In Step S35, if there is no record that includes the user's operation information in external devices (NO in Step S35), the Steps S34 and S35 are repeated until such a record is detected. If there are some records that include the user's operation information in external devices (YES in Step S35), the routine proceeds to Step S36.

In Step S36, the detected records of pre-recorded video help information and regular help information are displayed in a view format on the display 161, as shown in FIG. 7.

For example, if the user's operation information indicates that the “COPY” button, the button A in Setting 1 and the button B in Setting 2 are pressed in this order before the help button 163, the following records that include this information in their operation logs are displayed in a view format:
(1) Regular help information;
(2) Pre-recorded video help information 1 of the User A (Operation Log: “COPY→Button A in Setting 1→Button B in Setting 2→Button C in Setting 3”); and
(3) Pre-recorded video help information 2 of the User C (Operation Log: “COPY→Button A in Setting 1→Button B in Setting 2→Button C in Setting 3→Button A in Setting 4”).

Here, if there is a record of pre-recorded video help information that does not include this information in its operation log, it is not displayed. For example, a record of pre-recorded video help information that includes “COPY→Button A in Setting 1→Button C in Setting 2→Button B in Setting 3” in its operation log, is never displayed.

The user selects a record among those displayed in a view format. Then, it is judged in Step S37, whether or not it is a record of pre-recorded video help information. If it is a record of pre-recorded video help information (YES in Step S37), then it is judged in Step S38, whether or not the user who requests for operation support and the user who created the record of pre-recorded video help information are identical, based on the user information included in the record.

If the users are identical (YES in Step S38), in Step S39, a disclosed version of video data including unmasked confidential information, included in the selected record, is played on the display 161, and the voice data also included in the record is played by the speaker 18. After that, the routine proceeds to Step S43.

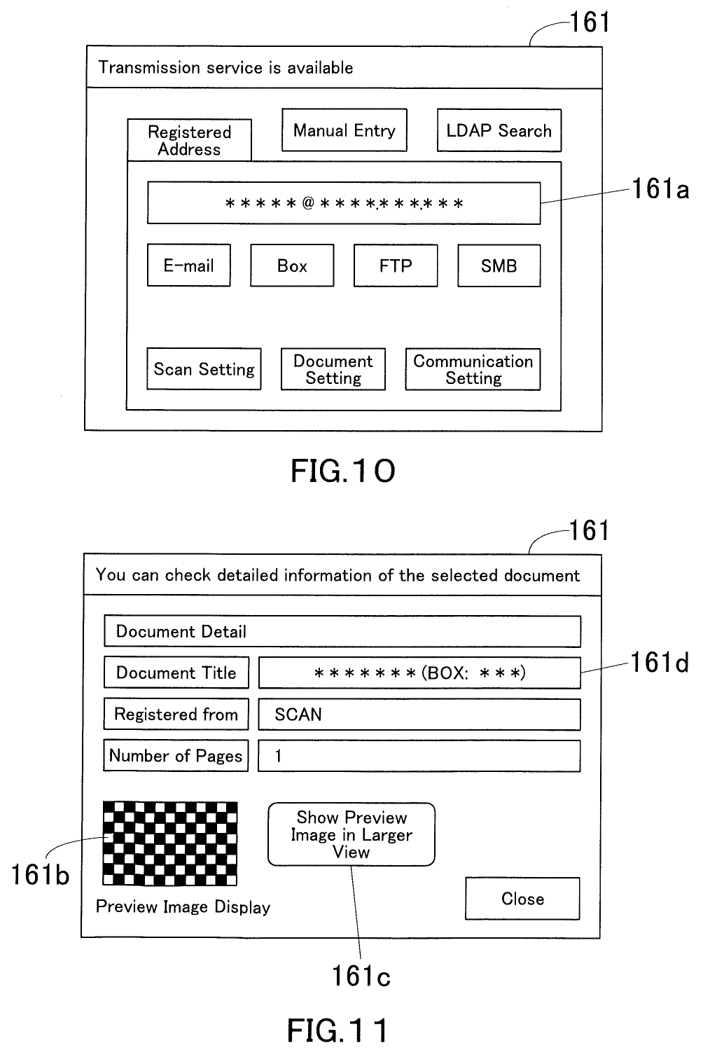

If the users are not identical in Step S38 (NO in Step S38), a closed version of video data including masked confidential information, included in the selected record, is played on the display 161, and the voice data also included in the record is played by the speaker 18. After that, the routine proceeds to Step S43. The confidential information included in the closed version of video data, which corresponds to a user ID, an electronic mail address 161a, a document title 161d, a preview image 161b and other information, is hidden as illustrated in a play screen of FIG. 10 and FIG. 11. Thus, even if the user presses the “Show Preview Image in Larger View” key 161c, he/she cannot view a preview image in a larger view.

In Step S37, if it is not a record of pre-recorded video help information (NO in Step S37), then it is judged in Step S41, whether or not it is a record of regular help information. If it is a record of regular help information (YES in Step S41), the prepared video and voice data included in the record are played in Step S42. After that, the routine proceeds to Step S43. If it is not a record of regular help information (NO in Step S41), the routine goes back to Step S37.

In Step S43, it is judged whether or not the user performed any operation. If the user did not perform any operation (NO in Step S43), the routine proceeds to Step S45. If the user performed an operation (YES in Step S43), a process is executed accordingly in Step S44. After that, the routine proceeds to Step S45.

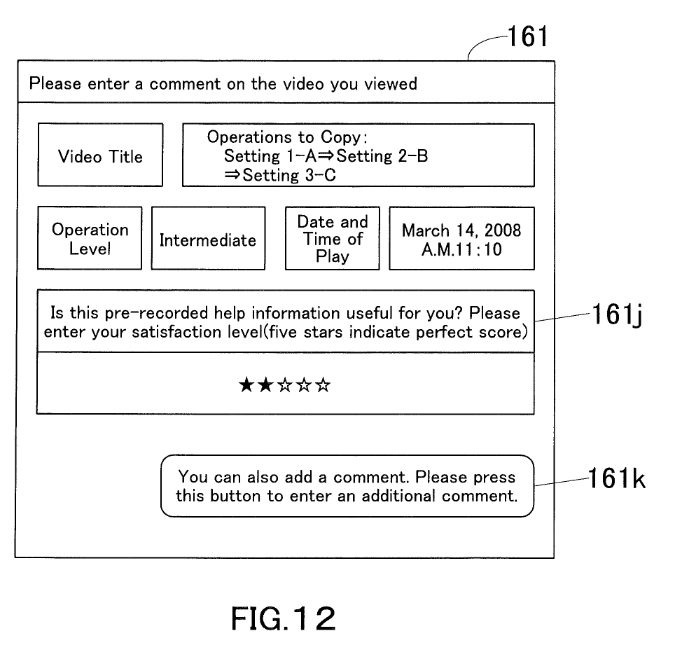

In Step S45, it is judged whether or not the playback of the video and voice data included in the record is completed. If it is not completed yet (NO in Step S45), the routine goes back to Step S43. If it is completed (YES in Step S45), then in Step S46, a comment entry screen shown in FIG. 12 is displayed on the display 161 and the routine waits until the user who viewed the playback of the video and voice data included in the record of pre-recorded video help information enters a comment in the comment entry screen, and a comment entry process is executed accordingly.

In the comment entry screen shown in FIG. 12, an entry field 161j that is used to enter a user's “Satisfaction Level” with the usefulness of the record of pre-recorded video help information is displayed, and a message button 161k that is used to add more comments is also displayed. The “Satisfaction Level” is rated on a scale of the number of “★” marks, indicating how the record is useful. Pressing the message button 161k, the user can enter a comment. An entered satisfaction level and comment are registered with a connection to the video data, as a part of the record of pre-recorded video help information, so that other users later could decide whether or not to use the record, with reference to the registered information. Furthermore, information to add one to the number of the users who have used the record of pre-recorded video help information is transmitted to the storage location of the record, and thereby the total number of the users is updated. Therefore, users who may later encounter an operation trouble would be able to select a record of pre-recorded video help information that leads to the shortest way to resolve the operation trouble, with reference to the satisfaction level, the comment, the total number of the users and other information displayed on the display 161.

Back to FIG. 9, after execution of the comment entry process in Step S46, it is judged in Step S47, whether or not the user finished all the operations for this time. If the user did not finish yet (NO in Step S47), the routine goes back to Step S43. If the user finished (YES in Step S47), the routine terminates.

As described above, in this embodiment, a user who operates the MFP 1 uses a record of pre-recorded video help information recorded in the memory 21 of the MFP 1. Meanwhile, a user who operates the MFP 2 also may use a record of pre-recorded video help information recorded in the memory 21 of the MFP 1.

For example, a user who operates the MFP 2 presses the “COPY” button and the button A in Setting 1 in this order before the help button 163, then this operation information is transmitted to the MFP 1 together with the user information. And the MFP 1 detects any records of help information that include this operation information and transmits necessary information to display the records in a view format, to the MFP 2. The procedure continued after that is the same as the one represented by the flowchart shown in FIG. 9. However, the process to select a closed version of video data including masked confidential information or a disclosed version of video data including unmasked confidential information, may be executed by the MFP 1 or the MFP 2, whichever. If the process is executed by the MFP 1, user information of the user who operates the MFP 2 will be transmitted to the MFP 1.

As described above, in this embodiment, the video data consisting of data exchanged between the MFP 1 and the support terminal 3 is recorded in the memory 21 or an external memory, meanwhile the voice data consisting of a conversation between the user and the support staff is also recorded in the memory 21 or another memory, with a connection to the video data. The video and voice data recorded in advance can be played according to an instruction given by the user or another user. Therefore, it would be convenient to record in advance in the memory 21 or another memory, a lot of records including video and voice data created for specific user operation states, since other users who may later encounter an operation trouble that is similar to any of the past operation troubles, can resolve the trouble by theirselves, with reference to a playback of the video and voice data. And thus, it would not be necessary anymore to upload FAQ onto a Website or have staff in support centers answer a user inquiry every operation trouble.

Furthermore, once a user encounters an operation trouble, other users also would encounter the same operation trouble with a high probability. Thus, the video and voice data recorded in advance in the memory 21 are practical and effective for users who need operation support. Support information sharing is effective for users since it fulfils problem-solving information. In addition, reduction of repeated same inquiries is effective for staff in support centers since they can focus on answering irregular and difficult inquiries that should be explained well enough.

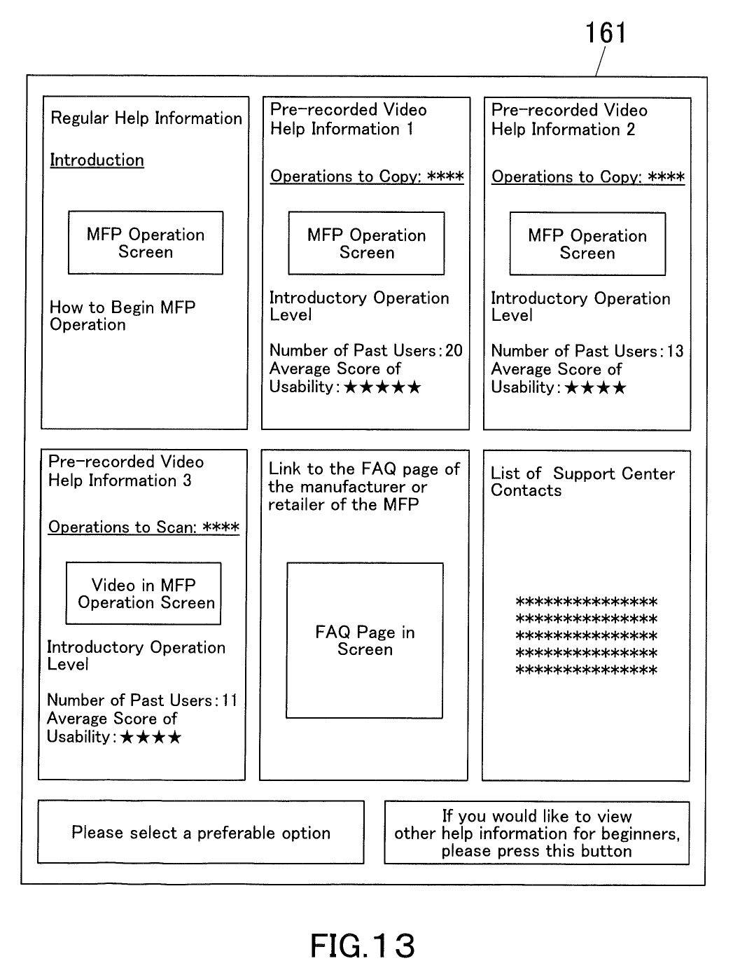

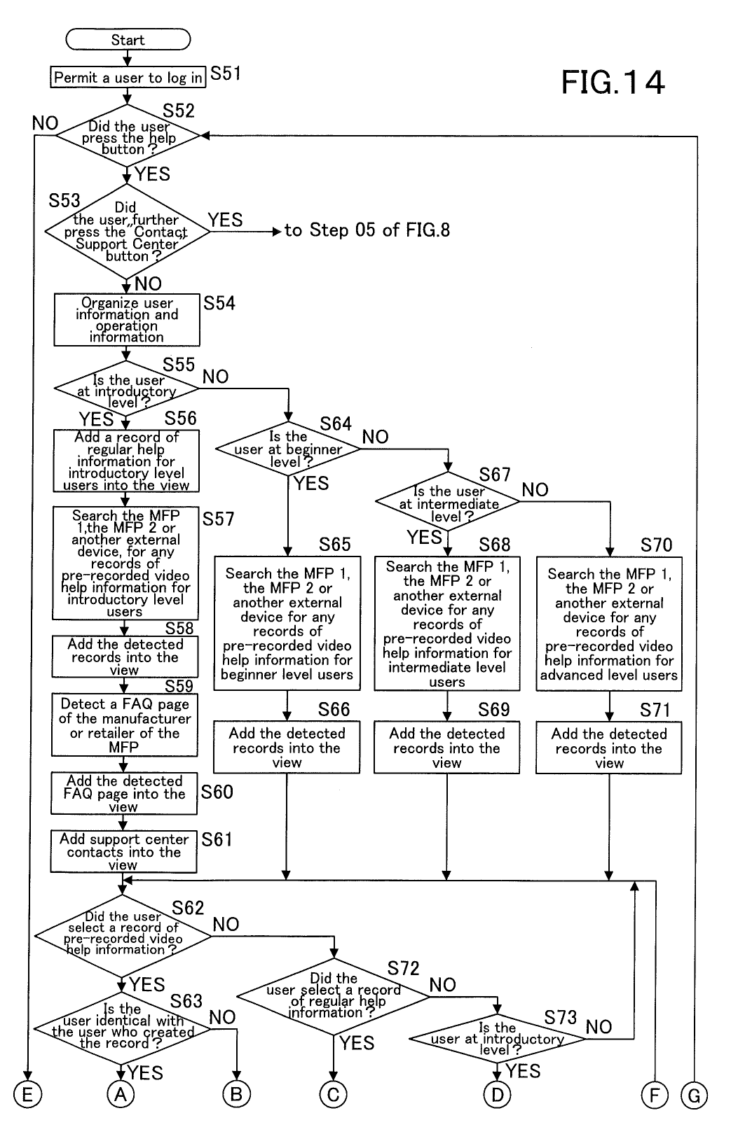

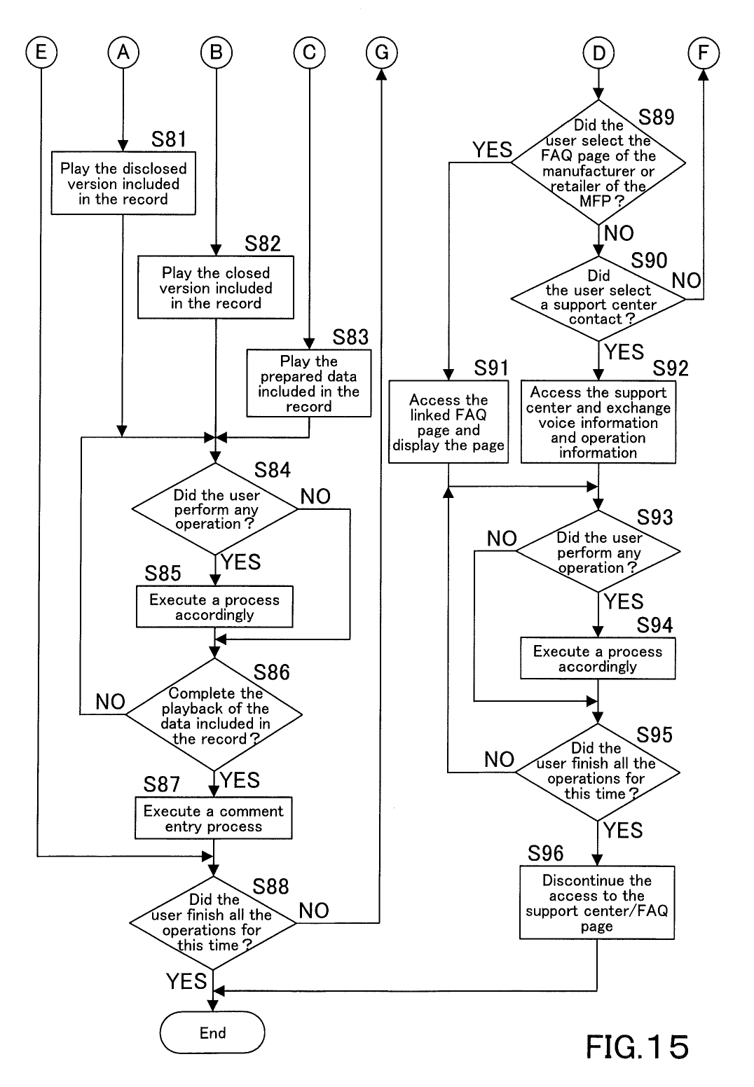

Hereinafter, another embodiment of the present invention will be explained with FIG. 13, FIG. 14 and FIG. 15.

For example, a user presses the help button 163 without performing many operations before that. Then, a lot of records of help information that include this operation log are displayed in a view format and it is not easy to find among those displayed, a record of help information that the user really needs.

In such a case, the controller 20 of the MFP 1 judges that the user is at beginner level, and the following information is detected:
(1) Regular help information for beginner level users, for example “How to Begin Operation”; and
(2) Pre-recorded video help information including the comment “Introductory Operation Level” and the large number of users who have used the records,
   and as illustrated in FIG. 13, these are displayed in a view format on the display 161, together with the following information:
(3) Link to the FAQ page of the manufacturer or retailer of the MFP; and
(4) List of support center contacts.

The user can select a preferable option among these displayed. If the user selects a record of regular help information or pre-recorded video help information, the video and voice data included in the record is played.

If the user selects the FAQ page, the MFP 1 accesses the linked page and the user can view FAQ at once.

If the user selects a list of support center contacts, more detailed information is displayed. And the user further selects a support center contact among the list, then the MFP 1 accesses the support center contact.

Hereinafter, a procedure executed in the MFP 1 in this embodiment explained above, will be further explained with reference to flowcharts shown FIG. 14 and FIG. 15. This procedure is executed by the CPU of the main controller 20 of the MFP 1, according to an operation program recorded in a recording medium such as the ROM or the memory 21.

A user is permitted to log in the MFP 1 in Step S51, and it is judged in Step S52, whether or not the user pressed the help button 163. If the user did not press the button (NO in Step S52), the routine proceeds to Step S88 of FIG. 15.

If the user presses the button (YES in Step S52), the selection buttons “Contact Support Center” and “Show Pre-recorded Video Help Information” are displayed on the display 161, and it is judged in Step S53, which button the user pressed. If it is the “Contact Support Center” button (YES in Step S53), the routine proceeds to Step S05 of FIG. 8. If it is the “Show Pre-recorded Video Help Information” button (NO in Step S53), user information of the user who pressed the “Show Pre-recorded Video Help Information” button and operation information indicating operations performed by the user are organized in Step S54. Then it is judged in Step S55, whether or not the user is at introductory level.

If the user is at introductory level (YES in Step S55), a record of regular help information for introductory level users is added into the view in Step S56. And in Step S57, the memory 21 of the MFP 1, an external memory of the MFP 2 or another external device is searched for any records of pre-recorded video help information for introductory level user. After that, the detected records of pre-recorded video help information for introductory level users are added into the view, in Step S58.

And a FAQ page of the manufacturer or retailer of the MFP 1 is detected in Step S59, and the detected FAQ page is added into the view in Step S60.

Subsequently, support center contacts are added into the view in Step S61. After that, the routine proceeds to Step S62.

In Step S55, if the user is not at introductory level (NO in Step S55), then it is judged in Step S64, whether or not the user is at beginner level. If the user is at beginner level (YES in Step S64), the memory 21 of the MFP 1, an external memory of the MFP 2 or another external device is searched for any records of pre-recorded video help information for beginner level users, in Step S65. After that, the detected records of pre-recorded video help information for beginner level users are added into the view, in Step S66. Then, the routine proceeds to Step S62.

In Step S64, if the user is not at beginner level (NO in Step S64), then it is judged in Step S67, whether or not the user is at intermediate level. If the user is at intermediate level (YES in Step S67), the memory 21 of the MFP 1, an external memory of the MFP 2 or another external device is searched for any records of pre-recorded video help information for intermediate level users, in Step S68. After that, the detected records of pre-recorded video help information for intermediate level users are added into the view, in Step S69. Then, the routine proceeds to Step S62.

In Step S67, if the user is not at intermediate level (NO in Step S67), the memory 21 of the MFP 1, an external memory of the MFP 2 or another external device is searched for any records of pre-recorded video help information for advanced level users, in Step S70. After that, the detected records of pre-recorded video help information for advanced level users are added into the view, in Step S71. Then, the routine proceeds to Step S62.

The user selects a record of help information among those displayed. And it is judged in Step S62, whether or not it is a record of pre-recorded video help information. If it is a record of pre-recorded video help information (YES in Step S62), the user who requests for operation support and the user who created the record of pre-recorded video help information are identical, based on the user information included in the record, in Step S63.

If the users are identical (YES in Step S63), the disclosed version of video data including unmasked identification information, among the video data included in the selected record of pre-recorded video help information, is played on the display 161 and the voice data also included in the record is played by the speaker 18, in Step S81 of FIG. 15. After that, the routine proceeds to Step S84.

In Step S63 of FIG. 14, if the users are not identical (NO in Step S63), the closed version of video data including masked confidential information, among the video data included in the record of pre-recorded video help information, is played on the display 161 and the voice data also included in the record is played by the speaker 18, in Step S82. After that, the routine proceeds to Step S84.

Meanwhile in Step S62 of FIG. 14, if it is not a record of pre-recorded video help information (NO in Step S62), then it is judged in Step S72, whether or not it is a record of regular help information. If it is a record of regular help information (YES in Step S72), the prepared video and voice data included in the record is played in Step S83 of FIG. 15. After that, the routine proceeds to Step S84. If it is not a record of regular help information (NO in Step S72), then it is judged in Step S73, whether or not the user is at introductory level. If the user is not at introductory level (NO in Step S73), the routine goes back to Step S62. If the user is at introductory level (YES in Step S73), the routine proceeds to Step S89 of FIG. 15.

In Step S84, it is judged whether or not the user performed an operation. If the user did not perform any operation (NO in Step S84), the routine proceeds to Step S86. If the user performed an operation (YES in Step S84), a process is executed accordingly in Step S85. After that, the routine proceeds to Step S86.

In Step S86, it is judged whether or not the playback of the video and voice data included in the record of help information is completed. If it is not completed yet (NO in Step S86), the routine goes back to Step S84. If it is completed (YES in Step S86), then in Step S87, a comment entry screen shown in FIG. 12 is displayed on the display 161 and the routine waits until the user who viewed the playback of the video and voice data included in the record of pre-recorded video help information enters a comment in the comment entry screen, and a comment entry process is executed accordingly.

After execution of the comment entry process, it is judged in Step S88, whether or not the user finished all the operations for this time. If the user did not finish yet (NO in Step S88), the routine goes back to Step S52 of FIG. 14. If the user finished (YES in Step S88), the routine terminates.

Subsequently, it is judged in Step S89, whether or not the user selects the FAQ page of the manufacturer or retailer of the MFP 1. If the user selects the FAQ page (YES in Step S89), the linked FAQ page is accessed and displayed on the display 161 in Step S91. After that, the routine proceeds to Step S93.

In Step S89, if the user does not select the FAQ page (NO in Step S89), then it is judged in Step S90, whether or not the user selects a support center contact. If the user does not select any (NO in Step S90), the routine goes back to Step S62. If the user selects one (YES in Step S90), then an access to the selected support center is made and the operation information is exchanged during a conversation with the support center, in Step S92. After that, the routine proceeds to Step S93.

In Step S93, it is judged whether or not the user performed an operation. If the user did not perform any operation (NO in Step S93), the routine goes back to Step S95. If the user performed an operation (YES in Step S93), a process is executed accordingly in Step S94. After that, the routine proceeds to Step S95.

In Step S95, it is judged whether or not the user finished all the operations for this time. If the user did not finish yet (NO in Step S95), the routine goes back to Step S93. If the user finished (YES in Step S95), the access to the support center or the FAQ page is discontinued in Step S96. After that, the routine terminates.

As described above, in this embodiment, even if the user presses the help button 163 without performing many operations before that, suitable records of pre-recorded video help information can be provided to the user in an effective manner.

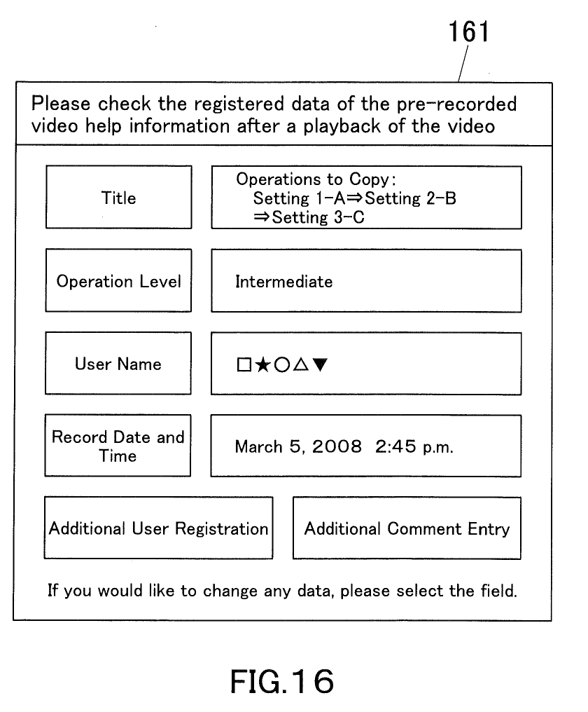

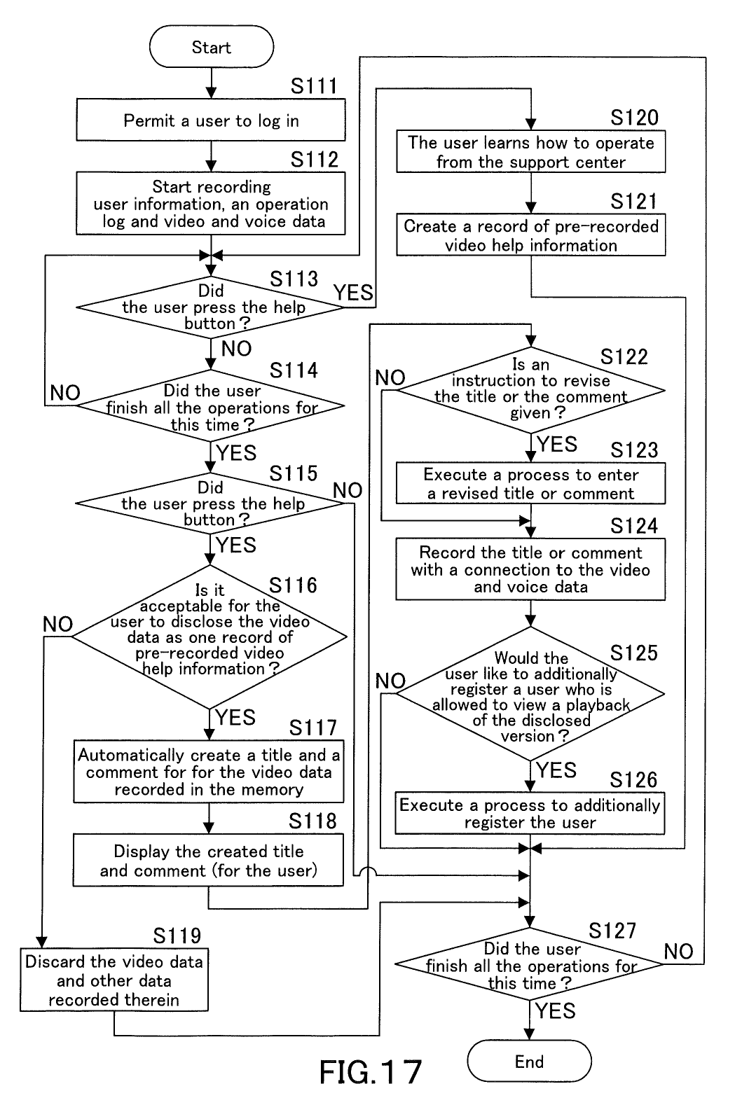

FIG. 16 and FIG. 17 relate to yet another embodiment of the present invention.

When a user encounters an operation trouble and learns how to operate the MFP 1 from a co-worker or another nearby person, not from a support staff in the support center, video data consisting of operation screens and other data and voice data consisting of a conversation between the user and the nearby person are recorded together, so that those could be disclosed as a record of pre-recorded video help information.

In such a case, it would be convenient that not only the user who learnt how to operate but also the person who instructs how to operate, to view a playback of the disclosed version of video data. Thus, in this configuration, users who are allowed to view a playback of the disclosed version of video data can be additionally registered.

FIG. 16 shows a registration screen to additionally register a user who is allowed to view a playback of the disclosed version of video data. The current user's user name, i.e. the user name of the user who created a record of pre-recorded video help information is entered via this registration screen. Furthermore, when the “Additional User Registration” button is pressed, a user name of a user to be additionally registered can be entered via the screen.

In this embodiment, when the “Additional Comment Entry” button is pressed, a comment can be additionally entered in the comment field where an operation level is already described. A comment may be additionally entered in another field provided separately.

The registration screen shown in FIG. 16 is used in the embodiment to be explained with a flowchart shown in FIG. 17. On the other hand, in the embodiment explained with FIG. 8, this registration screen used in FIG. 17 may be displayed after creation of a record of pre-recorded video help information, so that a user who is allowed to view a playback of the disclosed version of video data could be additionally registered and a comment could be additionally entered via the registration screen.

FIG. 17 is a flowchart to explain a procedure executed in the MFP 1. This procedure is executed by the CPU of the main controller 20 of the MFP 1, according to an operation program recorded in a recording medium such as the ROM or the memory 21.

A user is permitted to log in the MFP 1 in Step S111. And in Step S112, a process to record the user's user information and operation log is started, a process to record video data consisting of operation screen information and other data is started, and also a process to record voice data consisting of a conversation between the user and another user who instructs how to operate, is started.

In Step S113, it is judged whether or not the user pressed the help button 163. In this embodiment, if the user did not press the help button 163 (NO in Step S113), then it is judged in Step S114, whether or not the user finished all the operations for this job. If the user did not finish yet (NO in Step S114), the routine goes back to Step S113. If the user finished (YES in Step S114), the routine proceeds to Step S115.

In Step S115, whether or not the user pressed the help button 163. If the user presses the help button 163 (YES in Step S115), the routine proceeds to Step S116 since it is judged that the user could learn how to operate from someone. If the user did not press the help button 163 (NO in Step S115), the routine proceeds to Step S127 since it is judged that it is an ordinary operation to execute a job.

In Step S116, a check screen to determine whether or not to disclose the video data as one record of pre-recorded video help information, is displayed on the display 161, and the routine waits until the user performs an entry operation. If it is judged that the user would not like to disclose the video data (NO in Step S116), the video data consisting of operation screens displayed until the user finishes operation and the user's operation log, recorded in the memory 21, are discarded in Step S119. After that, the routine proceeds to Step S127.

If the user finds no problem in disclosing the video data (YES in Step S116), a title and a comment (an operation level) are automatically created for the video data recorded therein, based on the operation log recorded in the memory 21, in Step S117, and the created title and comment are displayed on the display 161 for the user, in Step S118. Then the routine proceeds to Step S122.

In Step S122, it is judged whether or not an instruction to revise the title or the comment is given. If such an instruction is given (YES in Step S122), a process to enter a revised title or comment is executed in Step S123, then the routine proceeds to Step S124. If such an instruction is not given (NO in Step S122), the routine directly proceeds to Step S124.

In Step S124, the title or comment is recorded with a connection to the video and voice data. Then in Step S125, the registration screen shown in FIG. 16 is displayed on the display 161 so that the user could determine whether or not to additionally register a user who is allowed to view a playback of the disclosed version of video data. If the user additionally registers a user who is allowed to view a playback of the disclosed version (YES in Step S125), a process to additionally register the user is executed in Step S126, then the routine proceeds to Step S127. Here, the user may simply enter an ID, a user name or etc. of the user who instructed how to operate, for example. If the user does not additionally register any user (NO in Step S125), the routine proceeds directly to Step S 127.

Like in the embodiments explained with reference to the flowcharts shown in FIG. 9, FIG. 14 and FIG. 15, a record of pre-recorded video help information that a user created with an operation support of a nearby person who instructs him/her how to operate, as described above, will be disclosed and used by other users who encounter an operation trouble.

In Step S113, if the user presses the help button 163 (YES in Step S113), an access to the support center is made and the user learns how to operate in Step S120. And a process to create a record of pre-recorded video help information is executed in Step S121, then the routine proceeds to Step S127. The process to create a record of pre-recorded video help information is executed in the same way as explained with reference to the flowchart of FIG. 8.

In Step S127, it is judged whether or not the user finished all the operations for this time. If the user did not finish yet (NO in Step S127), the routine goes back to Step S113. If the user finished (YES in Step S127), the routine terminates.

Both two types of video data: a disclosed version and a closed version, may be continuously recorded from start of recording video data in Step S112 until finish of user operation in Step S114. Alternatively, only video data including unmasked confidential information may be recorded and the video data including confidential information that is masked or kept unmasked depending on the user, later may be played.

As described above, in this embodiment, the video data consisting of operation screens displayed when the user learns how to operate from a nearby person and the voice data consisting of a conversation between them are recorded in the memory 21 of the MFP 1 or an external memory, and the recorded video and voice data are played according to a request from the user or other users. Therefore, it would be convenient to record in advance in the memory 21 or another memory, a lot of records including video and voice data for specific user operation states, since other users who may later encounter an operation trouble that is similar to any of the past operation troubles, can resolve the trouble by theirselves, with reference to a playback of the video and voice data. Thus, it would not be necessary any more to upload FAQ onto a Website or have staff in support centers answer a user inquiry every operation trouble.

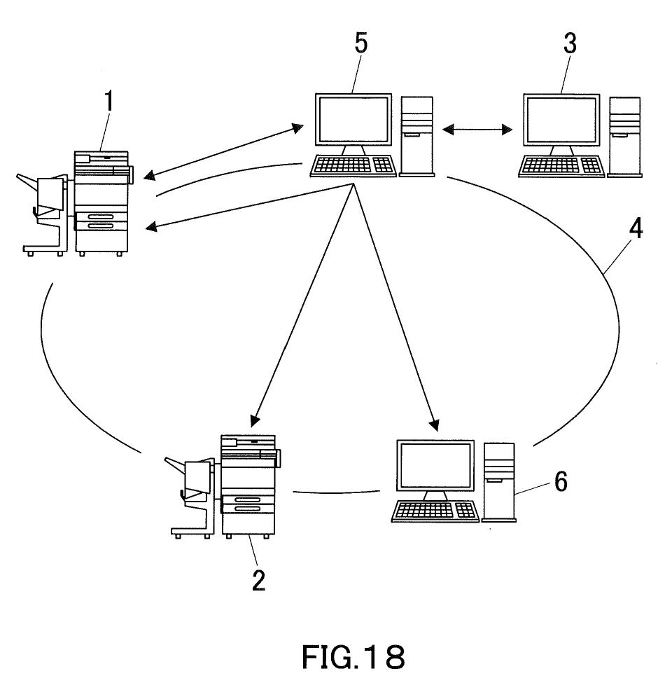

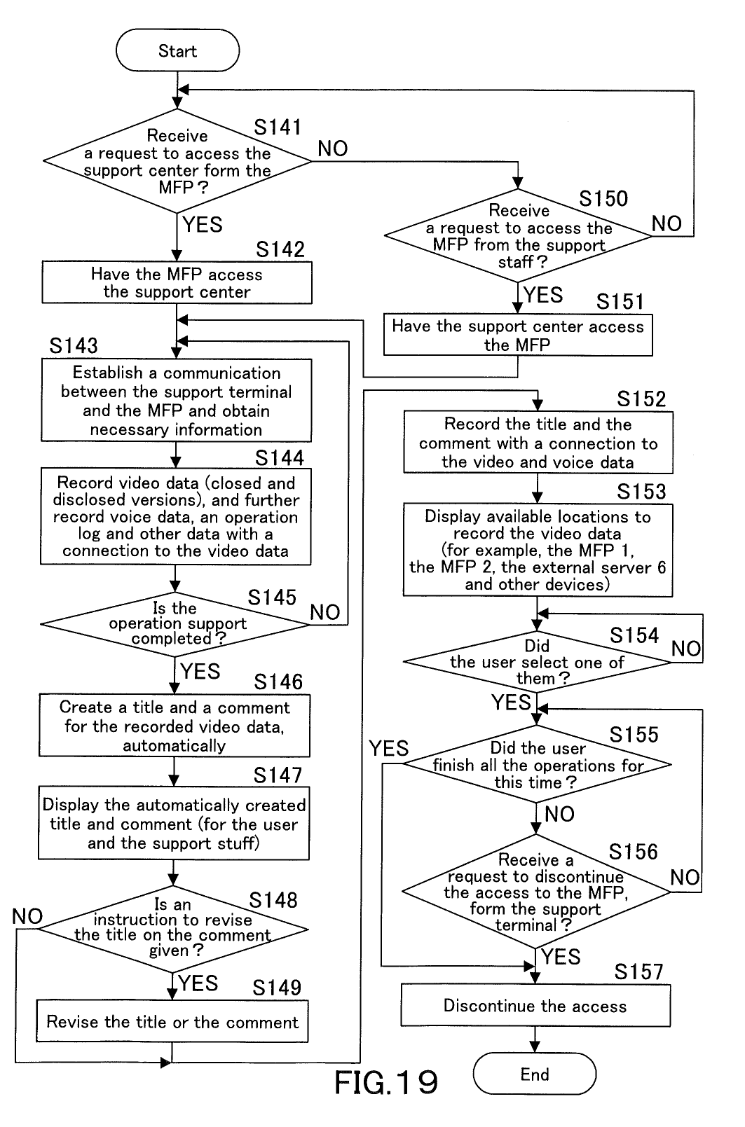

FIG. 18 and FIG. 19 relate to still yet another embodiment of the present invention.

In this embodiment, a server 5 is provided in the support center or another location between the MFP 1 and the support terminal 3, and under the control of the server 5, the video and voice data are recorded and records of pre-recorded video help information are created. Here, the video and voice data may be recorded in the MFP 1, the server 5, another server 6 or the MFP 2, whichever.

FIG. 19 is a flowchart to further explain the operations of the server 5, shown in FIG. 18. The server 5 is a personal computer, and includes: a CPU that controls the entire server 5; a ROM that stores an operation program; a RAM that serves as an operation area for the CPU; a memory that is a hard disk drive from example; a display that is a liquid crystal display for example; an entry portion having a keyboard, a mouse and etc.; a network interface that serves to communicate with the MFP 1, the MFP 2, the server 6 and other devices via the network 4; and etc., which are not shown in Figures.

The procedure shown in FIG. 19 is executed by the CPU of the server 5, according to an operation program recorded in a recording medium.

In Step S141, it is judged whether or not a request to access the support center is received from the MFP 1. If it is received (YES in Step S141), a process to access the support center is executed in Step S142.

And in Step S143, a communicate between the MFP 1 and the support terminal 3 is established and necessary information such as operation screen information, voice information, operation information of the MFP 1 and user information is obtained.

Then in Step S144, a video recording process is executed to record video data consisting of operation screen information and other information, and also record voice data, an operation log, user information and other information with a connection to the video data. Here, two types of video data: a disclosed version and a closed version are recorded. Alternatively, only video data including unmasked confidential information is recorded, so that the video data including the confidential information that is masked or kept unmasked depending on the user who gave an instruction to play the video data, later could be played.

Subsequently, it is judged in Step S145, whether or not the operation support is completed. If it is not completed yet (NO in Step S145), the routine goes back to Step S143. If it is completed (YES in Step S145), a title and a comment are automatically created for the recorded video data, in Step S146. And the automatically created title and comment are displayed on the display 161 and also transmitted to the support terminal 3, so that the user and the support staff could know them, in Step S147. Then it is judged in Step S148, whether or not an instruction to revise the title or the comment is given.

If such an instruction is given (YES in Step S148), a process to revise the title or the comment is executed in Step S149, then the routine proceeds to Step S152. If such an instruction is not given (NO in Step S148), the routine proceeds directly to Step S149.

In Step S152, the title and the comment are recorded with a connection to the video and voice data. After that, available locations to record the video data (for example, the MFP 1, the MFP 2, the external server 6 and other devices) are displayed on the MFP 1 and the support terminal 3 in Step S153, and the routine waits until the user of the MFP 1 or the support staff selects among the locations in Step S154. If the user of the MFP 1 or the support staff selects any of them (YES in Step S154), the video data and other data are transmitted to the selected location. After that, it is judged in Step S155, whether or not the user finished all the operations for this time.

If the user finished (YES in Step S155), the routine proceeds to Step S157. If the user did not finished yet (NO in Step S155), then it is judged in Step S156, whether or not a request to discontinue the access to the MFP 1 is received from the support terminal 3. If it is not received (NO in Step S156), the routine goes back to Step S155. If a request to discontinue the access is received (YES in Step S156), the routine proceeds to Step S157.

In Step S157, a process to discontinue the access is executed, and the routine terminates.

Meanwhile n Step S141, if a request to access the support center is not received from the MFP 1 (NO in Step S141), then it is judged in Step S150, whether or not a request to access the MFP 1 is received from the support staff. If it is not received (NO in Step S150), the routine goes back to Step S141. If it is received (YES in Step S150), a process to access the MFP 1 is executed in Step S151, and the routine proceeds to Step S143.

As described above, a record of pre-recorded video help information created by the server 5, is displayed for the user who requested for operation support, in the same way as described in the embodiments of FIG. 9, FIG. 14 and FIG. 15.

In other words, concretely, according to an instruction given by the user who requests for operation support operating an image forming apparatus, any record including an operation log that corresponds to operations performed by the user who requests for operation support is detected among the records of pre-recorded video help information and the prepared records of regular help information. And one or more than one record detected among them is transmitted to the image forming apparatus, together with a title and a comment. And when the user who operates the image forming apparatus selects any of them, the video and voice data included in the selected record is transmitted to the image forming apparatus.

After a playback of the video and voice data, an answer to a questionnaire and/or a comment about usability of the video and voice data, are (is) entered into an entry server 3 via the image forming apparatus. And the answer and/or the comment are (is) recorded in the memory 21 with a connection to the video data.

When the video data is recorded, the server 3 can register a user who is allowed to view a playback of video data including unmasked confidential information, according to operation of the user who operates the image forming apparatus.

As described above, in the embodiment explained with FIG. 18 and FIG. 19, the video data consisting of data exchanged between the MFP 1 and the support terminal 3 is recorded in the memory 21 of the MFP 1 or an external memory, and the voice data consisting of a conversation between the user and a support staff is also recorded in the memory 21 or an external memory, with a connection to the video data. Therefore, it would be convenient to record in advance in the memory 21 or another memory, a lot of records including video and voice data for specific user operation states, since other users who may later encounter an operation trouble that is similar to any of the past operation troubles, can resolve the trouble by theirselves, with reference to a playback of the video and voice data. And thus, it would not be necessary anymore to upload FAQ onto a Website or have staff in support centers answer a user inquiry every operation trouble.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image forming apparatus comprising:
a communicator that is capable of communicating with a support terminal operated by a support staff who is in charge of operation support about the image forming apparatus;
a controller that records video data consisting of data exchanged with the support terminal by the communicator, in an internal or external memory of the image forming apparatus, and further records voice data consisting of a conversation between a user who operates the image forming apparatus and the support staff, also in the internal or external memory, with a connection to the video data; and
a player that plays the video and voice data recorded therein, according to an instruction given by the user or another user.

2. An image forming apparatus comprising:
a controller that records video data consisting of operation screens displayed with operations of a user who operates the image forming apparatus, in an internal or external memory of the image forming apparatus, and further records voice data consisting of a conversation between the user and a support staff, also in the internal or external memory, with a connection to the video data; and
a player that plays the video and voice data recorded therein, according to an instruction given by the user or another user.

3. The image forming apparatus recited in claim 1, wherein:
the controller records user information of the user and an operation log corresponding to operations performed by the user at least until start of communicating with the support terminal, in the internal or external memory, with a connection to the video data.

4. The image forming apparatus recited in claim 2, wherein:
the controller records user information of the user and an operation log corresponding to operations performed by the user, in the internal or external memory, with a connection to the video data.

5. The image forming apparatus recited in claim 3, further comprising:
a creator that creates a title and a comment for the video data, based on the operation log and/or a content of the support, and
wherein:
the controller records the title and comment created by the creator, in the internal or external memory, with a connection to the video data, and further revises the title and comment created by the creator, according to an instruction given by the user or the support staff.

6. The image forming apparatus recited in claim 4, further comprising:
a creator that creates a title and a comment for the video data, based on the operation log and/or a content of the support, and
wherein:
the controller records the title and comment created by the creator, in the internal or external memory, with a connection to the video data, and further revises the title and comment created by the creator, according to an instruction given by the user.

7. The image forming apparatus recited in claim 3, further comprising:
a detector that detects according to an instruction given by the user who requests for operation support, a record including data that corresponds to operations performed by the user among the records of pre-recorded video help information each including video data, voice data, an operation log, a title and a comment and the prepared records of regular help information, which are recorded in the internal or external memory, and
wherein:
the controller displays one or more than one record detected by the detector, on a display with its title and comment together in a list, and then when a record is selected among the list, the player plays the video and voice data included in the selected record.

8. The image forming apparatus recited in claim 7, further comprising:
an entry portion that is capable of entering an answer to a questionnaire and/or a comment about usability of the video and voice data, after a playback of the video and voice data, and
wherein:
the controller records the entered answer and/or comment in the internal or external memory, with a connection to the video data.

9. The image forming apparatus recited in claim 1, wherein:
the controller records in the internal or external memory, two types of video data: first video data including masked confidential information and second video data including unmasked confidential information.

10. The image forming apparatus recited in claim 9, wherein:
the player plays either the first video data or the second video data depending on the user who requests for operation support, when an instruction is given by the user.

11. The image forming apparatus recited in claim 1, wherein:
the controller records the video data including unmasked confidential information; and
the player plays the video data including the confidential information that is masked or kept unmasked depending on the user who requests for operation support, when an instruction is given by the user.

12. The image forming apparatus recited in claim 10, wherein:
the controller is capable of registering a user who is allowed to view a playback of the second video data including unmasked confidential information, with an operation of the user who operates the image forming apparatus.

13. The image forming apparatus recited in claim 1, wherein:
the controller is capable of transmitting the video and voice data to another image forming apparatus if an instruction is received therefrom.

14. A server apparatus existing in a communication pathway between an image forming apparatus and a support terminal of a support staff who is in charge of operation support about the image forming apparatus, comprising:
a communicator that is capable of communicating with the image forming apparatus and the support terminal;
a controller that records video data consisting of data exchanged between the image forming apparatus and the support terminal and obtained by the communicator, in an internal or external memory of the server apparatus, and further records voice data consisting of a conversation between a user who operates the image forming apparatus and the support staff, also in the internal or external memory, with a connection to the video data; and
a transmitter that transmits the video and voice data recorded therein to the image forming apparatus or another image forming apparatus, according to an instruction received therefrom.

15. The server apparatus recited in claim 14, wherein:
the controller records user information of the user and an operation log corresponding to operations performed by the user at least until start of communicating with the support terminal, in the internal or external memory, with a connection to the video data.

16. The server apparatus recited in claim 15, further comprising:
a creator that creates a title and a comment for the video data, based on the operation log and/or a content of the support, and
wherein:
the controller records the title and comment created by the creator, in the internal or external memory, with a connection to the video data, and further revises the title and comment created by the creator, according to an instruction given by the user or the support staff.

17. The server apparatus recited in claim 16, further comprising:
a detector that detects according to an instruction given by the user who operates the image forming apparatus and requests for operation support, a record including data that corresponds to operations performed by the user among the records of pre-recorded video help information each including video data, voice data, an operation log, a title and a comment and the prepared records of regular help information, which are recorded in the internal or external memory, and
wherein:
the controller transmits to the image forming apparatus, one or more than one record detected by the detector, with its title and comment together in a list, and then when a record is selected among the list by the user who operates the image forming apparatus and requests for operation support, the controller further transmits also to the image forming apparatus, the video and voice data included in the selected record.

18. The server apparatus recited in claim 17, further comprising:
a receiver that receives from the image forming apparatus, an answer to a questionnaire and/or a comment about usability of the video and voice data, after the image forming apparatus plays the video and voice data, and
wherein:
the controller records the received answer and/or comment in the internal or external memory, with a connection to the video data.

19. The server apparatus recited in claim 14, wherein:
the controller records in the internal or external memory, two types of video data: first video data including masked confidential information and second video data including unmasked confidential information.

20. The server apparatus recited in claim 19, wherein:
the transmitter transmits to the mage forming apparatus, either the first video data or the second video data depending on the user who operates the image forming apparatus and requests for operation support, when the user's instruction is received therefrom.

21. The server apparatus recited in claim 14, wherein:
the controller records the video data including unmasked confidential information; and
the transmitter transmits to the image forming apparatus, the video data including the confidential information that is masked or kept unmasked depending on the user who operates the image forming apparatus and requests for operation support, when the user's instruction is received therefrom.

22. The server apparatus recited in claim 20, wherein:
the controller is capable of registering a user who is allowed to view a playback of the video data including unmasked confidential information, with an operation of the user who operates the image forming apparatus.

23. A computer readable recording medium having a program recorded therein to make a computer of an image forming apparatus execute:
communicating with a support terminal operated by a support staff who is in charge of operation support about the image forming apparatus;
recording video data consisting of data exchanged with the support terminal, in an internal or external memory of the image forming apparatus, and further recording voice data consisting of a conversation between a user who operates the image forming apparatus and the support staff, also in the internal or external memory, with a connection to the video data; and
playing the video and voice data recorded therein, according to an instruction given by the user or another user.

24. A computer readable recording medium having a program recorded therein to make a computer of an image forming apparatus execute:
recording video data consisting of operation screens displayed with operations of a user who operates the image forming apparatus, in an internal or external memory of the image forming apparatus; and
playing the video data recorded therein, according to an instruction given by the user or another user.

25. A computer readable recording medium having a program recorded therein to make a server apparatus existing in a communication pathway between an image forming apparatus and a support terminal of a support staff who is in charge of operation support about the image forming apparatus, execute:
communicating with the image forming apparatus and the support terminal;
recording video data consisting of data exchanged between the image forming apparatus and the support terminal, in an internal or external memory of the image forming apparatus, and further recording voice data consisting of a conversation between a user who operates the image forming apparatus and the support staff, also in the internal or external memory, with a connection to the video data; and
transmitting the video and voice data recorded therein to the image forming apparatus or another image forming apparatus, according to an instruction received therefrom.
